(19) United States
(12) Patent Application Publication
(10) Pub. No.: US 2003/0026110 A1
(43) Pub. Date: Feb. 6, 2003

(54) Imaging apparatus

(75) Inventors: Masao Satoh, Saitama (JP); Makoto Toyota, Saitama (JP); Yasuo Shirai, Chiba (JP)

Correspondence Address: GREENBLUM & BERNSTEIN, P.L.C., 1941 ROLAND CLARKE PLACE, RESTON, VA, 20191, US

(73) Assignee: MORITEX CORPORATION, Tokyo (JP)

(21) Appl. No.: 10/211,588

(22) Filed: Aug. 5, 2002

(30) Foreign Application Priority Data
Aug. 6, 2001 (JP) 2001-238,425

(51) Int. Cl. F21S 4/00

(52) U.S. Cl. 362/572

(57) ABSTRACT

An illumination system previously determined for an illumination direction and an illumination position to an object to be observed is disposed to an imaging head, while a lens 4 is disposed to an apparatus body, so that the number of parts for the imaging head mounted to an apparatus body can be reduced, precision fabrication such as alignment of lens optical axis is no more necessary upon manufacture of the imaging head and optimum illumination can be illuminated in accordance with the magnification ratio or the object to be observed by merely exchanging the imaging head, illumination light optimal to the magnification ratio or object to be observed can be obtained with no provision of various kinds of expositive lens units.

### BACKGROUND OF THE INVENTION

1. Field of the Invention

This invention concerns an imaging apparatus for observing the surface of an object to be observed, which is particularly suitable to an imaging apparatus for observing users' skins or scalps under magnification in a case where cosmetic sales stuffs decide cosmetics or shampoos or rinses optimal to the users in accordance with conditions of users skins or scalps.

2. Related Art Statement

Recently, various measuring instruments and diagnostic instruments have been introduced not only in cosmetic counters of department stores but also in cosmetic stores in shopping streets.

Among all, magnifying observation apparatus such as CCD microscopes have become important as sales promotion aids since they can display skins to such a high magnification ratio as can not be seen usually, and sales stuffs can explain users while displaying, on a monitor, images of fine textures of skins formed by fine lines running in various directions, stains and freckles and roughened state of skins.

By the way, when the skins are observed, illumination light suitable to an object to be observed has to be applied.

For example, vertical illumination for applying an illumination light approximately just above the object is preferred in a case of observing tones on the surface of skins, sideway illumination of applying a light obliquely from the lateral side is preferred in a case of observing fine skin textures formed by fine lines running in various directions, and lateral illumination from one direction is preferred in a case of observing replica of the kinds.

Further, the amount of light required per unit area for picking-up images is different between a case of picking-images up at low magnification ratio and a case of picking-up images at high magnification ratio since the picking-up range is different.

That is, in a case of picking-up a relatively wide range of 1 to 2 cm diameter, illumination of diffusion light is preferred so that the entire area can be illuminated, wherein in a case of picking-up a relatively narrow range of 1 to 2 mm diameter, it is necessary to project a spot light that concentrates to the narrow range so as not to cause insufficiency in the amount of light.

For this purpose, as shown in FIG. 5, in an existent imaging apparatus 41, a main body 43 having an imaging device 42 for picking-up images of an object is mounted with an exchangeable lens unit 45 having a magnifying lens 44 at an optional magnification ratio, a main body 43 is formed with a power supply contact 46, and white LEDs 47, 47, - - - - that emit light upon receiving electric power from the contacts 46 are arranged circularly to each lens unit 45.

With the constitution described above, since the white LEDs 47, 47, - - - are disposed to each lens unit 45 and illumination is formed in accordance with the kind of the lens 44 and the kind of the object, optimal illumination in accordance with the magnification ratio and the kind of the object can be obtained by merely mounting each lens unit 45 to the apparatus body.

However, since an illumination system 47 comprising white LEDs is disposed in the lens unit 45 in the existent imaging apparatus 41, when it is intended to pick-up images by illuminating an illumination light suitable to an object or magnification ratio, plural kinds of lens units 45 have to be provided in accordance with the object and the magnification ratio.

For example, when it is intended to change the illumination method at an identical magnification ratio, a lens unit 45 identical for the magnification ratio and different only for the illumination system 47 is required. When it is intended to observe at a different magnification ratio, a lens unit 45 different in the combination of the lens 44 and the illumination system 47 is required.

In addition, since a lens unit 45 includes a lens 44 and an illumination system 47 integrated to each other, it has a number of parts and requires fine fabrication for aligning a lens optical axis, this results in problems that the manufacturing cost per unit increases and provision of plural kinds of lens units 45 increases the cost by so much.

Further, when a zoom mechanism moveable along the optical axis of the lens 44 is adopted, the imaging picking-up ratio can be varied without exchanging the lens 44 but, also in this case, the illumination system has to be exchanged in accordance with each of the image picking-up magnification ratios.

### OBJECT OF THE INVENTION

In view of the above, it is a technical subject of the present invention to obtain an illumination light suitable to an image picking-up magnification ratio or an object to be observed with no provision of plural kinds of expensive lens units.

### SUMMARY OF THE INVENTION

The foregoing subject can be attained in accordance with the present invention by an imaging apparatus of illuminating an illumination light to an object to be observed by way of an observation hole formed at the top end of an imaging head from the inside of the hole, and focusing images of the object taken by way of the observation hole by a lens and then picking-up the same by an imaging device disposed to an apparatus body, wherein the lens is disposed to the apparatus body being arranged on an optical axis identical with the imaging device, the imaging head is disposed exchangeably to the apparatus body so as to cover the lens, and a light emission portion of an illumination system is disposed to the imaging head for illuminating a light to the object along a predetermined illumination direction and at a predetermined illumination position.

According to the present invention described above, the lens is attached to the apparatus body and an illumination system is disposed to the imaging head mounted to the apparatus body.

Since the lens is not disposed to the imaging head, the number of parts for the imaging head is reduced and precision fabrication such as alignment of the lens optical axis is not necessary and, accordingly, manufacturing cost can be decreased.

Further, since the illumination system disposed to the imaging head is designed such that a light can be illuminated to the object along the predetermined irradiation direction and at the predetermined irradiation position, an appropriate illumination light can be applied in accordance with the magnification ratio or the object by merely exchanging the imaging head.

Further, in a preferred embodiment of the invention, the illumination system and the lens can be combined optionally by attaching the lens exchangeably to the apparatus body. Then, it is possible to change only the magnification ratio by using an identical illumination system or both of the magnification ratio and the illumination system.

Further, the foregoing subject can be attained in accordance with another invention by an imaging apparatus having a basic constitution identical with the invention described above, wherein a lens holder for positioning the lens on the optical axis identical with the imaging device is mounted detachably to the apparatus body, the imaging head is mounted exchangeably to the lens holder, and a light emission portion of an illumination system is disposed to the imaging head for illuminating a light along a predetermined illumination direction and at a predetermined illumination position.

Also in this invention, since the lens is not disposed to the imaging head, the number of parts for the imaging head is reduced, accurate fabrication such as alignment of the lens optical axis is not necessary and the manufacturing cost can be decreased, as well as appropriate illumination light can be illuminated in accordance with the magnification ratio or the object by merely exchanging the imaging head like that in the invention described previously.

Further, the illumination system is constituted in a further embodiment by disposing light emission devices as a light emission portion of the imaging head and forming a power supply circuit that conducts current to the emission devices in a state where the imaging head is mounted, or the illumination system is constituted in a further embodiment by disposing a light source of the illumination system to the apparatus body and disposing optical fibers for guiding a light of the light source to a light emission end as a light emission portion in a state where the imaging head is mounted.

In any of the cases, the light emission portion for illuminating the illumination light is disposed in the imaging head and can illuminate a light along any illumination direction and at any illumination position.

In a further embodiment, a lens mounted to the apparatus body is attached to a slider that slides on the optical axis and disposed moveably from an image picking-up position at low magnification ratio on the side of the imaging device as far as the image pick-up position at high magnification ratio on the side of the observation hole, and resiliently biased toward the image picking-up position at high magnification ratio on the side of the observation hole by the resiliency of the spring, and a pressing portion is formed to the imaging head for enforcing the slider into a position corresponding to a desired magnification ratio against the resiliency of the spring when the head is mounted to the apparatus body.

According to this embodiment, when the imaging head having the illumination system of a predetermined magnification ratio is mounted to the apparatus body, since the slider with the lens attached thereto is enforced as far as the predetermined position capable of observation at the magnification ratio against the resiliency of the spring, it is possible to change the magnification ratio and switch to the illumination system suitable to the ratio by an extremely simple procedure of merely mounting the imaging head.

In a still further embodiment, at least two kinds of light emission portions capable of illuminating lights individually are provided in which a polarizer is disposed to an optical channel extending from one light emission portion to the object, and a detector is disposed to an optical channel of light reflected from the object to the imaging device in a cross Nicol state relative to the polarizer.

According to this embodiment, since a direct reflection light illuminated from the one light emission portion and reflected on the surface of skins is cut, and only the indirect reflection light reflected at the inside of the skins reaches the imaging device, it is suitable to observation for stains or the like in the inside of the skins.

In a case of disposing a polarizer to an optical channel extending from the other light emission portion to the obstacle, the polarizer may be disposed in a parallel Nicol state relative to the detector.

### DESCRIPTION OF THE ACCOMPANYING DRAWINGS

FIG. 1 is an explanatory view showing an imaging apparatus according to the prevent invention;

FIGS. 2(a)-2(e) are explanatory views showing other embodiments of an imaging head;

FIG. 3 is an explanatory view showing another embodiment of the present invention;

FIG. 4 is an explanatory view showing a further embodiment of the present invention; and

FIG. 5 is an explanatory view showing an existent apparatus.

### PREFERRED EMBODIMENTS OF THE INVENTION

Preferred embodiments of the present invention will be described specifically based on the appended drawings.

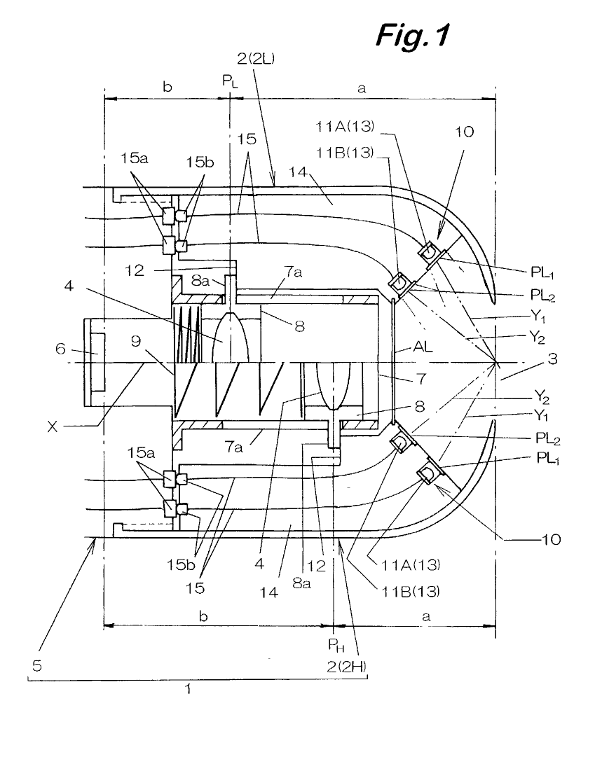

In an imaging apparatus shown in FIG. 1, an object to be observed is illuminated by an illumination light through an observation hole 3 formed at the top end of the imaging head 2 from the inside thereof, and an image of the object taken through the observation hole 3 is focused by a lens 4, and is picked-up by an imaging device 6 arranged in an apparatus body 5.

Lens 4 is disposed in the apparatus body 5 being arranged on the same optical axis X as the imaging device 6. In this embodiment, the lens 4 is attached on a slider 8 which slides in the direction of the optical axis X in a lens cylinder 7 mounted exchangeably on the apparatus body 5, and is arranged moveably from a low magnification imaging position PL on the side of the imaging device 6 to a high imagination imaging position P_{H} on the side of the observation hole 3.

The lens cylinder 7 is formed with a guide groove 7a that guides a guide pin 8a stood on the slider 8. A spring 9 is mounted in the lens cylinder for energizing the slider 8 toward the high magnification imaging position P_{H} on the side of the observation hole 3.

The imaging head 2 is mounted exchangeably on the apparatus body 5 so as to cover the lens 4. Inside the imaging head, are provided light emission portions 11a and 11b of an illumination system 10 which illuminate light to the object along an illuminating direction and at an illuminating position established previously and a pressing portion 12 which adjusts the magnification ratio by pressing the guide pin 8a of the slider 8 protruded from the lens cylinder 7 to a position corresponding to a desired magnetization ratio against resiliency of the spring 9.

The light emission portions 11a and 11b include light emission devices 13, 13, - - - such as high brightness white LEDs arranged on a flange portion 14 positioned at the periphery of the lens cylinder, and a power supply circuit 15 for causing each of light emission portions 11A and 11B to emit light by switching each of the light emission devices 13, through a switch (not shown).

The light emission portions 11A and 11B are used for observing the surface and the inside of skins. A polarizer PL₁ is positioned in an optical channel Y₁ extending from one light emission portion 11A for observing the inside of the skins as far as the object, and a detector AL is positioned on an optical axis X of light which is reflected by the skin as the object as far as the imaging device 6 in a cross Nicol state to the polarizer PL₁.

When the light is illuminated from the light emission portion 11A to the skins as the object, a light reflected on the skin surface and maintained in its polarized state is cut by the detector AL and only the light reflected on the skin surface and changed for the polarized state reaches the imaging device 6.

Thus, the illumination by the light emission portion 11A is suitable to the observation of stains, etc., formed below epidermis

Further, a polarizer PL₂ is disposed in the optical channel Y₂ extending from the other light emission portion 11B to the object in a parallel Nicol state to the detector AL. When a light is illuminated from the other light emission portion 11B to the skins as the object, the light reflected at the inside of the skins and changed for the polarized state is cut by the detector AL while the light reflected on the skin surface and maintained in its polarized state reaches the imaging device 6.

Accordingly, illumination by the light emission portion 11B is suitable to observation for unevenness on the skin surface such as wrinkles or fine textures.

The power supply circuit 15 includes spaced electrodes 15a and 15b formed to the apparatus body 5 and the imaging head 2 and, when the apparatus body 5 and the imaging head 2 are mounted integrally, the electrodes 15a and 15b are in contact with each other to conduct current to the light emission device 13.

Further, the pressing portion 12 that adjusts the magnification ratio by pressing the guide pin 8a of the slider 8 into a predetermined position corresponding to the magnification ratio, thereby moving the slider 8 is formed on the inner periphery of an inner block 14 where the light emission devices 13, 13, - - - are arranged.

In this case, each of the dimensions for the imaging head 2 is determined so as to satisfy the following equations (1) and (2):

M=b/a (1)

(1/f)=(1/a)+(1/b) (2)

where f is a focal distance of the lens 4, a is a distance from an object (observation hole 3) to the lens 4, b is a distance from the lens 4 to the imaging face of the imaging device 6, and M is an optical magnification ratio of the lens.

For example, in a case where the focal distance of the lens 4 is defined as: f=15 mm, the entire length and the position of the pressing portion 12 are decided for the imaging head 2H for high magnification ratio (on the screen) of 120× (optical magnification: M=2), such that the distance from the object (observation hole 3) to the lens 4 is: a =22.5 mm and the distance from the lens 4 to the imaging face of the imaging device 6 is: b=45 mm. In this embodiment, each of the light emission devices 13, 13, - - - of the illumination system 10 of the imaging head 2H are circularly arranged near the observation hole 3 so as to illuminate a beam light to a narrow imaging range so that a sufficiently bright illumination light can illuminate the imaging range.

On the other hand, the entire length and the position of the pressing portion 12 are decided for the imaging head 2L for low magnification ratio (on the screen) of 30× (optical magnification ratio: M=0.5), such that the distance from the object (observation hole 3) to the lens 4 is: a=45 mm and the distance from the lens 4 to the imaging face of the imaging device 6 is: b=22.5 mm.

In this case, each of the light emission devices 13, 13, - - - of the illuminating system 10 of the imaging head 2L are circularly arranged at positions spaced apart as far as possible from the observation hole 3 to illuminate diffusion light, so that a relatively wide imaging range can be entirely illuminated uniformly.

The operation of the embodiment according to this invention constituted as described above will be explained.

At first, when it is intended for observation at a low magnification ratio, the imaging head 2L for low magnification is mounted to the apparatus body 5.

Since the pressing portion 12 of the low magnification imaging head 2L presses the pressing pin 8a of the slider 8 into the low magnification imaging position PL, the lens 4 is positioned at the low magnification position PL.

Further, when the low magnification imaging head 2L is mounted, the current supply circuit 15 conducts current by way of the electrodes 15a and 15b to the light emission device 13.

Then, when the observation hole 3 is abutted against the skins in a state where each of the light emission devices 13, 13, - - - is lighted-up, since each of the light emission devices 13, 13, - - - is positioned being relatively spaced apart from the observation hole 3, a relatively wide imaging range is illuminated entirely upon low magnification imaging and the images are intaken through the observation hole 3 and picked-up by the imaging device 6.

Then, when only the light emission device 13 of the light emission portion 11A is lighted-up, a polarized light passing through the polarizer PL₁ is illuminated on the skins as the object. Since the light reflected on the surface of the skins and maintained in its polarized state is cut by the detector AL in a cross Nicol relation while a light reflected on the inside of the skins to change its polarized state reaches the imaging device 6, this is suitable to a case of observing stains or the like formed below the epidermis.

On the other hand, when only the light emission device 13 of the light emission portion 11B is lighted-up, the polarized light passing through the polarizer PL₂ is illuminated on the skins as the object. Since the light reflected on the inside of the skins and changed for its polarized state is cut by the detector AL and the light reflected on the skin surface and maintained in its polarized state passes the detector AL in a parallel Nicol relation and reaches the imaging device 6, it is suitable to observation for unevenness such as wrinkles or fine texture on the surface of the skins.

The thus picked-up images can be displayed on a monitor, as well as they can be taken as image date into a personal computer for data processing.

Then, when it is intended to observe at a high magnification ratio, the high magnification imaging head 2H is mounted on the apparatus body 5.

Then, since the pressing portion 12 of the high magnification imaging head 2H urges the pressing pin 8a of the slider 8 into the high magnification imaging position PH_{H}, the lens 4 is positioned at the high magnification imaging position P_{H}.

Then, when the observation hole 3 is abutted against the skins in a state where each of the light emission devices 13, 13, - - - is lighted-up through the power supply circuit 15, since each of the light emission devices 13, 13, - - - is provided near the observation hole 3, a relatively narrow imaging range at the high magnification ratio is illuminated spotwise and the images are taken through the observation hole 3 and then picked-up by the imaging device 6.

The light emission portions 11A and 11B are used selectively for the observation like the case of using the low magnification imaging head 2L. The thus picked-up images can be displayed on a monitor, as well as they can be taken as image data into a personal computer for a data processing.

Although the description has been made to a case of using a variable magnification lens 4 slidable in the lens cylinder 7, the present invention is not limited only to this embodiment but a constant magnification lens may be used, for example, such that a lens cylinder in which a lens is fixed at a predetermined position is detachably mounted on the apparatus body 5, or such a cylinder is formed not detachably on the apparatus body 5.

In the case of using the constant magnification lens described above, different illumination lights may be illuminated by exchanging the imaging head 2.

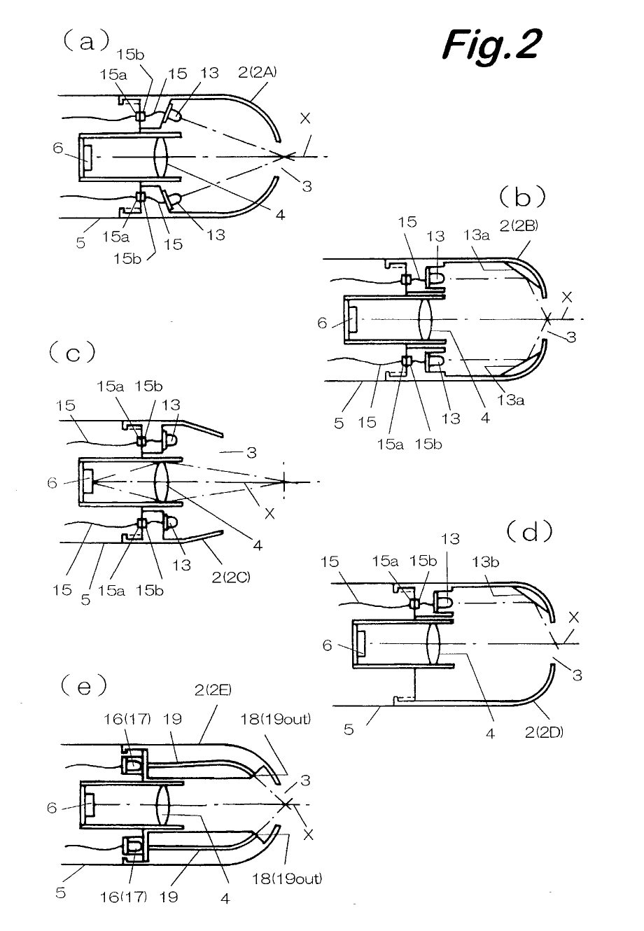

FIG. 2(a) shows an imaging head 2A for vertical illumination suitable to a case where a smooth surface with less unevenness is observed, which is arranged at such a position that an angle of illumination of the light emission device 13 to the optical axis X is small, so that the light can be illuminated at a position almost just above the object.

FIG. 2(b) shows an imaging head 2B for sideway illumination suitable to a case where an object of highly uneven surface is observed. A mirror 13a for reflecting a light from a light emission device 13 is arranged in the imaging head 2B, so that the object is illuminated from the side thereof.

FIG. 2(c) shows an imaging head 2C suitable to a case where the object of highly uneven surface such as a printed board mounted with parts is picked-up without touching the object, in which images of the object placed at a predetermined imaging position spaced apart from the observation hole 3 by a predetermined distance can be focused on the imaging device 6.

FIG. 2(d) shows an imaging head 2D suitable to a case where a replica of the object (skin) is observed. A mirror 13b is arranged in the imaging head 2D so that the replica can be illuminated sideway by a light only in one direction.

Accordingly, different kinds of illumination light can be illuminated merely by exchanging the imaging heads 2 (2A-2D).

While the description has been made to the case of using the light emission devices 13, 13, - - - as the light emission portions 11A and 11B of the illumination system 10, the present invention is not limited only to this embodiment but optical fibers may also be used as shown in FIG. 2(e).

That is, in this embodiment, light emission devices 17, 17, - - - as light sources 16 of the illumination system 10 are arranged in the apparatus body 5 and the apparatus body 5 and the imaging head 2 are integrally mounted to an imaging head 2E. The light is inputted to optical fibers, and they are guided as far as the light emission and 19_{OUT} for illumination.

As described above, since each of the imaging heads 2 is not provided with the lens 4, not only the manufacturing cost for the imaging head 2 can be reduced, but also an optimum illumination can be selected corresponding to an object to be observed by the lens 4 mounted on the apparatus 5 by exchanging the imaging head 2 and, if the lens cylinder 7 is made exchangeable, the magnification ratio and the illumination method can be selected optionally in combination with the imaging head 2.

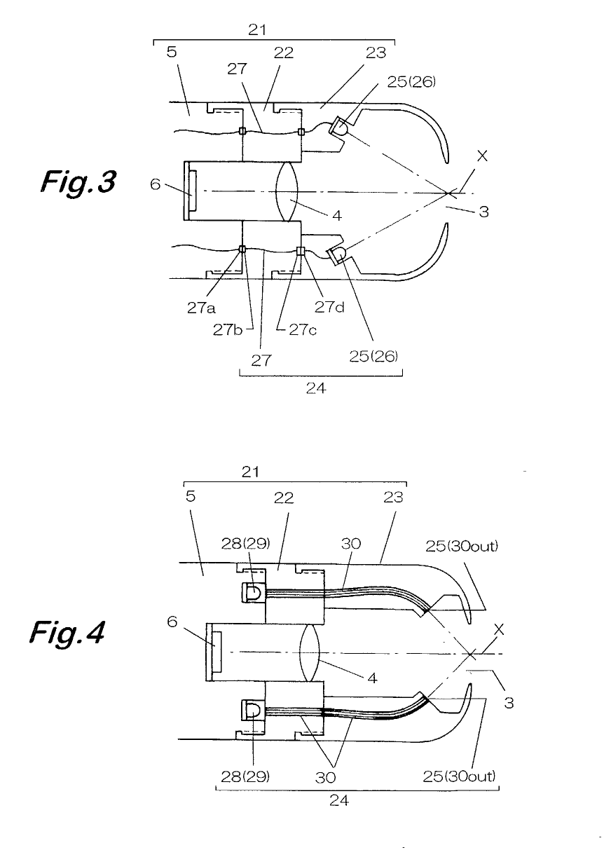

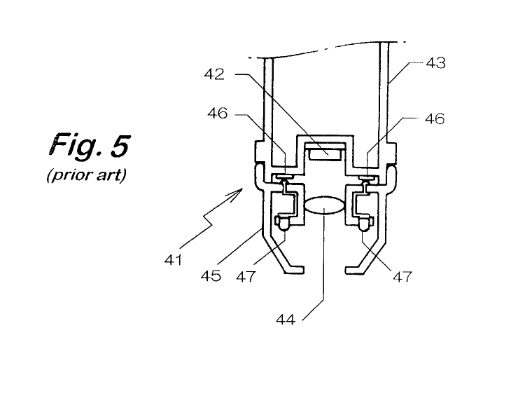

FIG. 3 is an explanatory view illustrating another imaging apparatus according to the present invention. Those portions in common with FIG. 1 carry the same reference numerals, for which detailed descriptions are to be omitted.

In an imaging apparatus 21 of this embodiment, a lens holder 22 for positioning a lens 4 on the optical axis X identical with the imaging device 6 is mounted detachably on the apparatus body 5 and an imaging head 23 is mounted exchangeably on the lens holder 22.

The imaging head 23 is provided with light emission devices 26, 26, - - - as a light emission portion 25 of an illumination system 10 for illuminating a light to an object along a predetermined direction and at a predetermined position, and a power supply circuit 27 that conducts current to the light emission device 26 is formed to the apparatus body 5, the lens holder 22 and the imaging head 23.

The power supply circuit 27 includes spaced electrodes 27a to 27d formed in the apparatus body 5, the lens holder 22 and the imaging head 23 and, when they are mounted integrally, the electrodes are in contact with each other to conduct current to the light emission device 26.

This imaging apparatus 21 can observe an object at a predetermined magnification ratio by exchanging the lens holder 22, and an illumination light optimal to the object can be illuminated by exchanging to the imaging head 23 optimal to the mounted lens holder 22.

Since the imaging head 23 is not provided with the lens 4 as described above, manufacturing cost for the imaging head 23 is reduced, and the magnification ratio and the kind of illumination can be selected optionally by the combination of the lens holder 22 and the imaging head 23.

In the lens holder 22, the lens 4 may be arranged slidably in the direction of the optical axis X as shown in FIGS. 1 and 2 or, alternatively, it may be fixed.

In the illumination system 24 of the imaging head 23, light emission devices 29 as light sources 28 for the illumination system 24 may be arranged in the apparatus body 5. The apparatus body 5, the lens holder 22, and the imaging head 23 may be mounted integrally and, in this state, optical fibers 30 are disposed in the imaging head 23 for guiding a light from the light sources 28 to a light emission end 30_{OUT} as a light emission portion 25 of the imaging head 23.

It may suffice that the optical channel such as optical fibers or perforations for guiding the light from the light emission device 29 to the incident end 30_{IN} of the optical fibers 30 are formed to the lens holder 22.

As has been described above according to the present invention, since the lens is not disposed to the imaging head, the manufacturing cost for the imaging head can be reduced. Further, since the imaging head has a light emission portion formed therein that can illuminate a light along a predetermined illumination direction and at a predetermined illumination position to the object, it can provide an excellent effect capable of selecting optimal illumination in accordance with the object to be observed by the lens disposed to the apparatus body and the magnification ratio thereof, by exchanging the imaging head.

The present disclosure relates to subject matter contained in priority Japanese Patent Application No. 2001-238,425 filed on Aug. 6, 2001, the contents of which is herein expressly incorporated by reference in its entirety.

What is claimed is:

1. An imaging apparatus for illuminating an illumination light by way of an observation hole formed at the top end of an imaging head from the inside of the hole to an object to be observed and focusing images of the object taken by way of the observation hole by a lens and then picking-up the same by an imaging device disposed to an apparatus body, wherein
the lens is disposed being arranged on an optical axis identical with the imaging device to the apparatus body, the imaging head is mounted exchangeably to the apparatus body so as to cover the lens, and a light emission portion of an illumination system is disposed to the imaging head for illuminating a light to the object along a predetermined illumination direction and at a predetermined illumination position.

2. An imaging apparatus as defined in claim 1, wherein the lens is mounted exchangeably to the apparatus body.

3. An imaging apparatus as defined in claim 1, wherein light emission devices as light emission portions of the illumination system are disposed to the imaging head, and a power supply circuit is disposed to the apparatus body and the imaging head for conducting a current to the light emission device in a state where they are mounted integrally.

4. An imaging apparatus as defined in claim 1, wherein the light source of the illumination system is disposed to the apparatus body, and the imaging head includes optical fibers for guiding the light of the light source as far as a light emission end as the light emission portion for illumination in a state where the apparatus body and the imaging head are mounted integrally.

5. An imaging apparatus for illuminating an illumination light by way of an observation hole formed at the top end of an imaging head from the inside thereof to an object to be observed, focusing images of the object intaken by way of the observation hole by a lens and picking-up the same by an imaging device disposed to an apparatus body, wherein
a lens holder for positioning the lens on the optical axis identical with the imaging device is detachably mounted to the apparatus body, the imaging head is mounted exchangeably to the lens holder and a light emission portion of an illumination system for illuminating a light along the predetermined illumination direction and at a predetermined illumination position to the object is disposed to the imaging head.

6. An imaging apparatus as defined in claim 5, wherein the light emission device as the light emission portion of the illumination system is disposed to the imaging head and a power supply circuit is formed to the apparatus body, the lens holder and the imaging head for conducting current to the light emission device in a state where they are mounted integrally therewith.

7. An imaging apparatus as defined in claim 5, wherein the light source of the illumination system is disposed to the apparatus body, and the imaging head includes optical fibers for guiding a light from the light source as far as the light emission end as the light emission portion for illumination in a state where the apparatus body, the lens holder and the imaging head are mounted integrally.

8. An imaging apparatus as defined in claim 1, wherein the lens is attached to a slider sliding on an optical axis, and is disposed moveably from a low magnification imaging position on the side of the imaging device to a high magnification imaging position on the side of the observation hole, resiliently biased to the high magnification imaging position on the side of the observation hole by the resiliency of a spring, and a pressing portion is formed to the imaging head for pressing the slider to a position corresponding to a desired magnification ratio against the resiliency of the spring.

9. An imaging apparatus as defined in claim 1, comprising at least two kinds of light emission portions capable of illuminating lights individually in which a polarizer is disposed to an optical channel extending from one emission portion to the object, and a detector is disposed in an optical channel of a light reflected by the object and extending to an imaging device in a cross Nicol state to the polarizer.
